(19) United States
(12) Patent Application Publication
(10) Pub. No.: US 2026/0253033 A1
(43) Pub. Date: Aug. 27, 2026

(54) Technologies for Dynamically Generating Personalized Support Recommendations During a Live Call

(71) Applicant: The PNC Financial Services Group, Inc., Pittsburgh, PA (US)

(72) Inventor: Touseef Habib, Secaucus, NJ (US)

(21) Appl. No.: 19/539,226

(22) Filed: Feb. 13, 2026

Related U.S. Application Data
(60) Provisional application No. 63/762,788, filed on Feb. 25, 2025.

(51) Int. Cl. G06Q 10/10; G06N 20/00; G06Q 30/016

(52) U.S. Cl. CPC G06Q 10/10; G06N 20/00; G06Q 30/016

(57) ABSTRACT

Technologies for dynamically generating personalized support recommendations during a live call include a compute device. The compute device includes circuitry configured to receive, through a real-time communication channel, a call in which a customer poses a question to a live agent. The question is provided in real-time to a retrieval augmented generation artificial intelligence system (“RAG system”). The RAG system retrieves relevant context from a knowledge base related to the question and generates a predicted recommendation. The predicted recommendation is provided to the live agent during the call.

### RELATED APPLICATIONS

This application claims the benefit of U.S. Provisional Application Serial No. 63/762,788 filed February 25, 2025 for “Technologies for Dynamically Generating Personalized Support Recommendations During a Live Call,” which is hereby incorporated by reference in its entirety.

### BACKGROUND

Support centers offer help to resolve issues, answer questions, and provide information and resources. Support centers can provide help to users within the organization or external customers. In a financial institution, for example, employees from various branches may call a support hotline for information about the financial institution’s policies, processes, and/or procedures. The financial institution’s customers may call a support hotline asking for information specific to that customer, such as their account information, transactions that were performed on their accounts, and/or their interest in other financial products offered by the bank.

Due to the call volume at support centers, there can be a long wait time, which can cause frustration to callers. Some support centers offer a callback option, but this option may not work for some customers as the callback time may not agree with the caller’s schedule. As an alternative to a live support agent, some support centers offer automated call systems. However, these automated systems tend to be robotic in answering questions, and cause frustration because callers are unable to express their intent in a semantic manner.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a call system with an artificial intelligence system to generate personalized support recommendations during a live call;

FIG. 2 is a simplified block diagram of at least one embodiment of a compute device of the system of FIG. 1;

FIGS. 3-5 are simplified block diagrams of at least one embodiment of a method for dynamically generating personalized support recommendations during a live customer call that may be performed by the system of FIG. 1; and

FIG. 6 is a simplified block diagram of at least one embodiment of a call system with dynamic support recommendations generated by an artificial intelligence system during live customer calls.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure, in some embodiments, dynamically generate context-aware personalized support recommendations during live customer interactions. For example, in some embodiments, the system may dynamically process spoken language from a call, extract semantic meaning, and provide actionable insights to the support agent. In some cases, the disclosure includes a retrieval augmented generation artificial intelligence system (“RAG system”) that processes the caller’s speech, searches through information in a knowledge base (e.g., caller’s history), and provides suggested resolutions to the call agent in real-time. Embodiments of this disclosure allow the RAG system to service the caller directly without a human in the loop. To do this effectively without a human in the loop, enough data from the prior interaction(s) will need to be collected to ensure proper service is provided. New callers with insufficient data will have a human in the loop while seasoned callers with enough data can be serviced by the system.

Some embodiments of this disclosure solve one or more technical problems. For example, the burden on live agents is decreased by providing a dynamically generated suggested resolution to the question posed by the customer. This also allows callers to be served faster, which reduces the wait time and provides quicker calls with support.

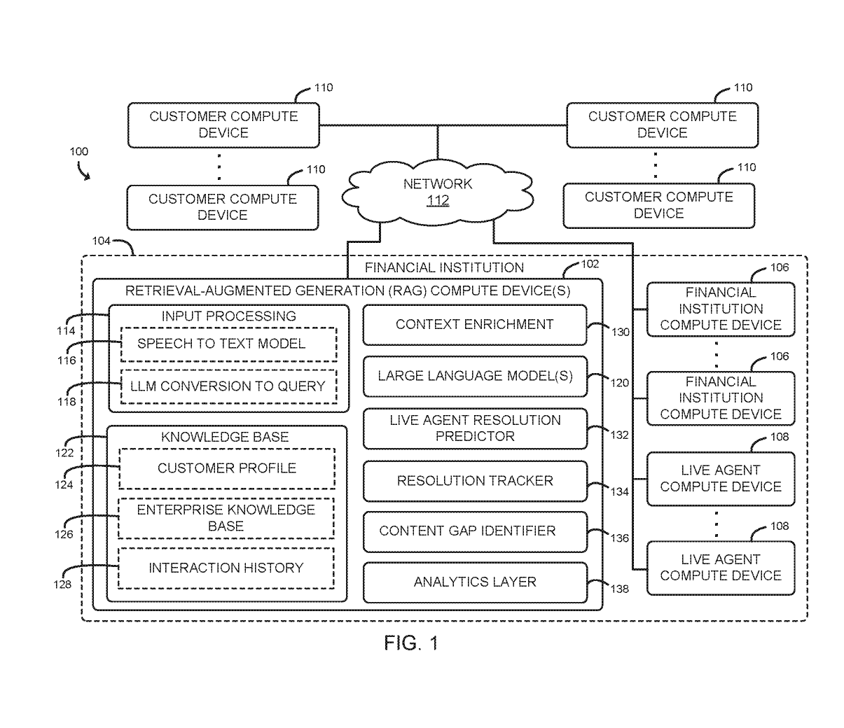

Referring now to FIG. 1, a system 100 for dynamically generating personalized support recommendations during a live call includes, in the illustrative embodiment, a retrieval-augmented generation (“RAG”) compute device(s) 102. The compute device(s) 102 may be located in a data center (e.g., a facility housing compute devices, thermal control equipment, power management equipment, and networking equipment to support the operations of the compute device) associated with a financial institution 104. In the illustrative embodiment, the RAG compute device(s) 102 are communicatively connected to a set of financial institution compute devices 106, a set of live agent compute devices 108, and a set of customer compute devices 110 via a network 112.

In some embodiments, the compute devices 106 and 108 may be associated with a financial institution, such as a bank. The financial institution compute devices 106, such as a mobile phone or tablet, could be used by employees of the financial institution to, among other things, make calls to a support hotline to talk with a live agent to ask questions, such as questions about the financial institution’s policies, procedures and/or processes. The live agent compute devices 108 could include internal software components of the financial institution that allow live agents to receive calls from financial institution compute devices 106 and suggested resolutions from the RAG compute device(s) 102. In some cases, the customer compute devices 110, which could be mobile phones or tablets, that could be used by customers of the financial institution to make calls to a support hotline to talk to live agents to ask questions, such as about the customers’ accounts or transactions. While the system 100 and methods performed by the system 100 are described herein with reference to the financial institution, the system 100 and its methods could be used in the context of other organizations as well.

In the illustrative embodiment, RAG compute device(s) 102 has optional input processing 114 with a speech to text model 116 and a large language model (LLM) conversion to query 118. In some cases, the input processing 114 receives a live stream (e.g., audio or video stream) of the call and converts this media stream to a text query that can be provided to large language model(s) 120 that generate a suggested resolution to the caller’s question. In some embodiments, the large language model(s) 120 could be multi-modal to accept the live stream from the call, in which case the input processing 114 that dynamically converts the media stream to text for input into the large language model(s) 120 would be optional.

As shown, the RAG compute device 102 includes a knowledge base 122 that is ingested with a variety of data that could aid in answering questions of the caller. In the example shown, the knowledge base 122 is ingested with customer profile data 124 specific to a customer, an enterprise knowledge base 126 that could be policies, procedures, and/or processes of the financial institution, and interaction histories 128 associated with each of the customer profiles that represent prior interactions with live agents. In the illustrative embodiment, the RAG compute device 102 includes context enrichment 130 that is configured to enrich the searching of the knowledge base 122 based on each interaction with the caller. The RAG compute device 102 includes, as shown, a live agent resolution predictor 132 configured to provide the output of the large language model(s) 120 to the respective live agent compute device 108. There is a resolution tracker 134 configured to keep track of suggested resolutions generated by the large language model(s) 120. As discussed herein, the resolution tracker 134 may update the interaction history 128 with successful resolutions to questions posed by the caller and associate those successful resolutions with the customer’s profile. In some cases, unsuccessful resolutions to questions posed by the caller can be analyzed by the content gap identifier 136 to determine whether there are gaps in the knowledge base that could be addressed. In the embodiment shown, the RAG compute device 102 includes an analytics layer 138 that is configured to what topics callers are calling about and tune the RAG compute device 102 to handle such calls.

While relatively few compute devices 102, 106, 108, 110 are shown in FIG. 1 for simplicity and clarity, it should be understood that the number of compute devices, in practice, may range in the tens, hundreds, thousands, or more. Likewise, it should be understood that the compute devices 102, 106, 108, 110 may be distributed differently or perform different roles than the configuration shown in FIG. 1. Further, though shown as separate compute devices 102, 106, 108, 110 in some embodiments, the functionality of one or more of the compute devices 102, 106, 108, 110 may be combined into fewer compute devices and/or distributed across more compute devices than those shown in FIG. 1.

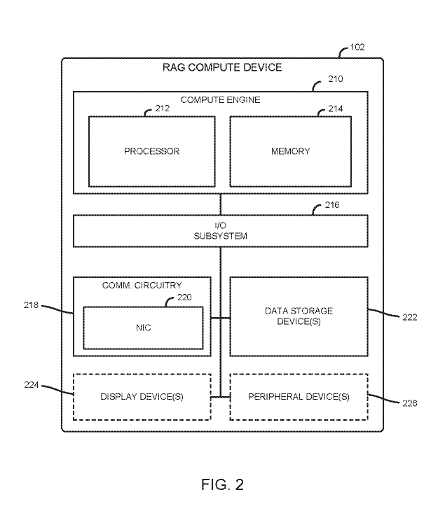

Referring now to FIG. 2, the RAG compute device 102 includes a compute engine 210, an input/output (I/O) subsystem 216, communication circuitry 218, and one or more data storage devices 222. In some embodiments, the RAG compute device 102 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the RAG compute device 102 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as large language models, customer profiles, enterprise knowledge base data, interaction histories, applications, libraries, and drivers.

The compute engine 210 is communicatively coupled to other components of the RAG compute device 102 via the I/O subsystem 216, which may be embodied as circuitry and/or components to facilitate input/output operations with the compute engine 210 (e.g., with the processor 212 and the main memory 214) and other components of the RAG compute device 102. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the RAG compute device 102, into the compute engine 210.

The communication circuitry 218 may be embodied as any communication circuit, device, or collection thereof, capable of enabling communications over a network between the RAG compute device 102 and another device (e.g., a live agent compute device 108, etc.). The communication circuitry 218 may be configured to use any one or more communication technologies (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the RAG compute device 102 to connect with another compute device (e.g., a live agent compute device 108, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the RAG compute device 102 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the RAG compute device 102 are housed in a single unit. However, in other embodiments, the components may be in separate housings, in separate racks of a data center, and/or spread across multiple data centers or other facilities. The compute devices 106, 108, 110 may have components similar to those described in FIG. 2 with reference to the RAG compute device 102. The description of those components of the RAG compute device 102 is equally applicable to the description of components of the compute devices 106, 108, 110. Further, it should be appreciated that any of the devices 106, 108, 110 may include other components, sub-components, and devices commonly found in a computing device, which are not discussed above in reference to the RAG compute device 102 and not discussed herein for clarity of the description.

In the illustrative embodiment, the compute devices 102, 106, 108, 110, are in communication via a network 112, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

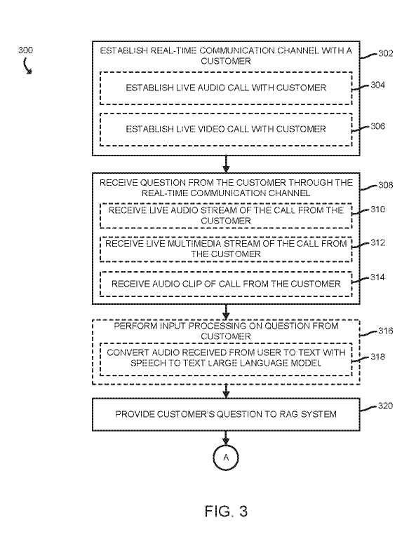

Referring now to FIG. 3, the system 100, and more specifically, the RAG compute device 102 and the live agent compute device 108, in the illustrative embodiment, may perform a method 300 for dynamically generating personalized support recommendations during live customer interactions. The method 300 begins with block 302 in which the financial institution compute device 106 and/or the customer compute device 110 establishes a real-time communication channel with the RAG compute device 102 and/or the live agent compute device 108. For example, the financial institution compute device 106 and/or the customer compute device 110 could call a phone number that establishes a call with the live agent compute device 100. In some embodiments, as explained herein, the call could initially be routed to the RAG compute device 102 instead of the live agent compute device 108 to determine whether the RAG compute device 102 can directly answer the question based on prior interactions, and then escalate to the live agent compute device 108 if there’s not enough prior interactions for the RAG compute device 102 to directly answer the question. In some cases, the financial institution compute device 106 and/or the customer compute device 110 establishes a real-time communication channel that is a live audio channel, such as a phone call, as shown by block 304. In other cases, the financial institution compute device 106 and/or the customer compute device 110 establishes a real-time video communication channel, such as through a video chat function of the financial institution’s mobile app or other live video channel as shown by block 306. The term “customer” in FIGS. 3-5 is broadly intended to encompass both internal and external customers (i.e., both the financial institution compute device 106 and the customer compute device 110).

The method 300 advances to block 308 in which a question is received through the real-time communication channel. Consider an example in which the real-time communication channel is a live audio channel, the question could be received as a live audio stream of the call with the question, as indicated by block 310. In cases where the real-time communication channel is a live video channel, the question could be received as a live video stream of the call with the question, as indicated by block 312. In some cases, an audio or video clip of the call that includes the question could be received, as indicated by block 314. As explained herein, the audio or video stream or clip could undergo input processing in some embodiments, as indicated by block 316. The input processing may include converting audio received in the call (e.g., audio or video stream) to text with a speech-to-text large language model, as indicated by block 318. In some embodiments, instead of input processing, a multi-modal large language model 120 could be used that does not require conversion of the audio to text for prompting. The method 300 advances to block 320 in which the customer’s question is provided to the RAG system 102.

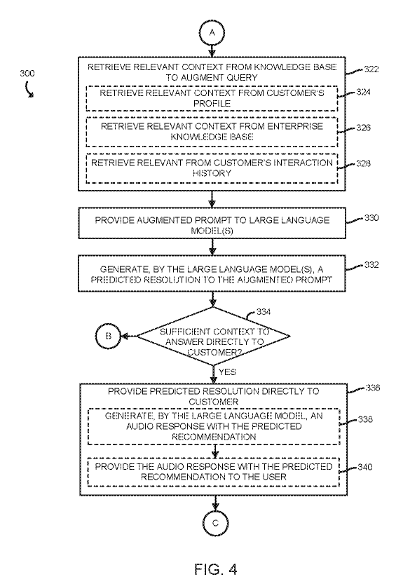

Referring to FIG. 4, the method 300 continues with the RAG system 102 retrieving relevant context from the knowledge base 122 to augment the customer’s question, as indicated by block 322. In some cases, the RAG system 102 retrieves the relevant context from the customer’s profile (block 324). By way of example, a financial institution compute device 106 may be identified by an employee number or other unique identifier of the user to determine which customer profile 124 corresponds with the financial institution compute device 106. Consider an example with an external customer, the appropriate customer profile 124 could be determined based on the phone number associated with the customer compute device 110 used to call. In some cases, the customer could be asked for identifying information to determine the appropriate customer profile 124. In some embodiments, the RAG system 102 may retrieve relevant context from the enterprise knowledge base 126 (block 326). The RAG system 102, in some cases, may retrieve customer interaction histories 128 (block 328). The method 300 continues to block 330 in which the RAG system 102 creates an augmented prompt with the context from the knowledge base 122 and provides the augmented prompt to the large language model(s) 120 as shown in block 330. The large language model(s) 120 generates a predicted recommendation based on the augmented prompt (block 332).

In some embodiments, the RAG system 102 determines whether there is sufficient context in the knowledge base 122 to directly answer the customer’s question (block 334). For example, the RAG system 102 could determine whether there is sufficient context based on the customer’s interaction history 128 and whether there is one or more prior interactions similar to the question posed by the customer. If the RAG system 102 generated a predicted recommendation that was successfully adopted by a live agent in a prior interaction that is similar to the question, the method 300 advances to block 336 and the RAG system 102 provides the predicted recommendation directly to the customer. In some cases, the large language model(s) 120 could generate an audio response with the predicted recommendation (block 338), which is provided to the customer 340. For example, the RAG system 102 could mimic a live conversation with the customer similar to the live agent in directly answering the customer’s question.

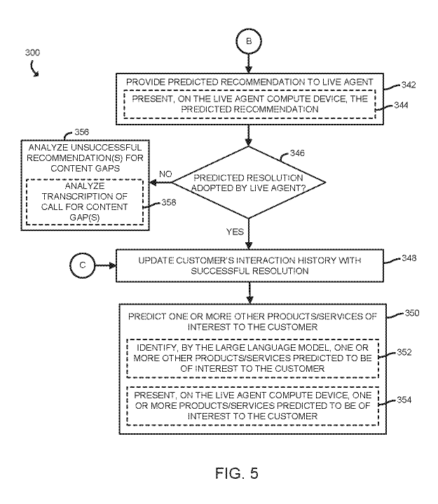

If the RAG system 102 determines there is insufficient context in the knowledge base 122 to directly answer the customer’s question, the method 300 advances to block 342 (FIG. 5). For example, the predicted recommendation is presented to the live agent compute device 108, as shown in block 344, such as by showing the predicted recommendation on the live agent’s call dashboard in real-time while the live agent is speaking with the customer. In some cases, the RAG system 102 may be configured to not attempt to answer directly, in which case the method 300 advances to block 342 without making a determination (block 334) whether there is sufficient context in the knowledge base 122 to answer the question directly.

Upon providing the predicted recommendation to the live agent compute device 108, the method 300 proceeds to block 346 in which a determination is made whether the live agent adopts the predicted recommendation. If the live agent adopts the predicted recommendation, the method advances to block 348 in which the RAG system 102 updates the interaction history 128 of the patient with the successful recommendation (block 348). In some cases, the RAG system 102 could make a prediction of one or more products and/or services of interest to the customer (block 350). For example, the RAG system 102 could identify one or more products and/or services for cross-selling to the customer as indicated in block 352, which could be presented to the live agent compute 108 (block 354), such as on the live agent’s call dashboard.

If the live agent does not adopt the predicted recommendation, the method 300 proceeds to block 356, in some embodiments, to analyze for content gaps in the knowledge base 122. For example, the RAG system 102 could analyze a transcription of the call between the customer and the live agent to determine whether there is insufficient content for the particular question to make a successful predicted recommendation as indicated in block 358. This analysis could identify topics that need to be supplemented in the knowledge base, which could enhance future predicted recommendations.

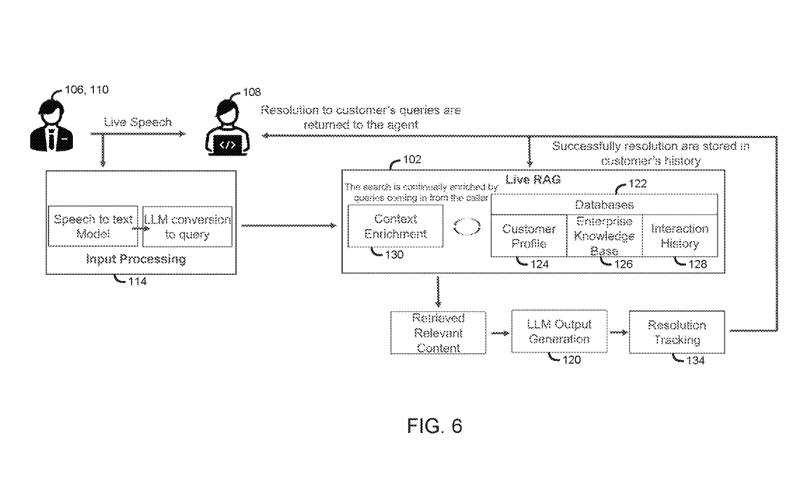

Referring now to FIG. 6, there is shown an example data flow for a support call with a customer. In this example, the customer compute device 106, 110 makes a call to a support hotline number to connect with the live agent compute device 108. The audio of the call, which includes the customer’s question, is fed to the input processing 114 in this example. The input processing 114 converts the audio of the call, particularly the customer’s question, to text with large language models 120. The text of the customer’s question is provided to the RAG system 102. As discussed herein, if the large language model(s) are multi-modal, input processing may be optional, and the audio stream of the call could be provided directly to the RAG system 102. In this example, the text of the customer’s question is provided to the RAG system 102, which retrieves relevant content from the knowledge base 122 to augment the customer’s question with relevant context. As discussed herein, the relevant content could be specific to the customer, which allows personalized recommendations to be generated by the RAG system 102. The large language model(s) 120 generatea a predicted recommendation in response to the customer’s question, which is provided to the live agent compute device 108. If the live agent compute device 108 adopts the predicted recommendation, the customer’s interaction history 128 will be updated to include the successful predicted recommendation. As discussed herein, the inclusion of successful predicted recommendations in the customer’s interaction history 128 could enrich future predicted recommendations and/or allow the RAG system 102 to respond directly to the customer.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. For example, while the above methods and systems are described in connection with a financial institution, it will be appreciated by those skilled in the art that the methods and systems could be equally used in the context of other institutions or organizations. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to receive, through a real-time communication channel, a call in which a customer poses a question to a live agent; provide the question in real-time to a retrieval augmented generation artificial intelligence system (“RAG system”); retrieve, with the RAG system, relevant context from a knowledge base related to the question; generate, by the RAG system, a predicted recommendation in response to the question based on the relevant context from the knowledge base; and provide, by the RAG system, the predicted recommendation to the live agent.

Example 2 includes the subject matter of Example 1, and wherein to provide the question to the RAG system comprises providing a live audio stream of the call from the customer to the RAG system.

Example 3 includes the subject matter of Examples 1 and 2, and wherein to provide the question to the RAG system comprises providing an audio clip of the call from the customer to the RAG system.

Example 4 includes the subject matter of Examples 1-3, and wherein to provide the question to the RAG system comprises providing a live multimedia stream of the call from the customer to the RAG system.

Example 5 includes the subject matter of Examples 1-4, and further comprising to perform input processing on the live audio stream of the call from the customer.

Example 6 includes the subject matter of Examples 1-5, and wherein to perform input processing comprises to convert, with one or more large language models, the live audio stream of the call from the customer to text.

Example 7 includes the subject matter of Examples 1-6, and wherein to receive relevant context from the knowledge base comprises to retrieve relevant context from a customer’s profile representing data specific to the customer that provided the question, and the RAG system is to generate the predicted recommendation that is personalized to the customer’s profile.

Example 8 includes the subject matter of Examples 1-7, and wherein to receive relevant context from the customer profile comprises identifying the customer with a unique identifier representing the customer.

Example 9 includes the subject matter of Examples 1-8, and wherein the customer’s profile includes data identifying one or more financial accounts associated with the customer with a financial institution associated with the live agent, and the RAG system is to generate the predicted recommendation personalized to the one of more financial accounts associated with the customer.

Example 10 includes the subject matter of Examples 1-9, and wherein to receive relevant context from the knowledge base comprises to retrieve relevant context from an enterprise knowledge base.

Example 11 includes the subject matter of Examples 1-10, and wherein the enterprise knowledge base comprises policies, processes and/or procedures of a financial institution.

Example 12 includes the subject matter of Examples 1-11, and wherein to receive relevant context from the knowledge base comprises to retrieve relevant context from one or more prior interactions of the customer with the RAG system.

Example 13 includes the subject matter of Examples 1-12, and further comprising to determine whether the one or more prior interactions of the customer with the RAG system provide sufficient context for the RAG system to directly answer the customer’s question without involvement by the live agent.

Example 14 includes the subject matter of Examples 1-13, and wherein in response to determining there is sufficient context for the RAG system to directly answer the customer’s question, provide the predicted recommendation directly to the customer from one or more large language models.

Example 15 includes the subject matter of Examples 1-14, and wherein to provide the predicted recommendation directly to the customer comprises generating, by the one or more large language models, an audio response to the customer with the predicted recommendation.

Example 16 includes the subject matter of Examples 1-15, and further comprising to determine whether the live agent adopts the predicted recommendation.

Example 17 includes the subject matter of Examples 1-16, and wherein in response to the live agent adopting the predicted recommendation, updating the knowledge base with the predicted recommendation.

Example 18 includes the subject matter of Examples 1-17, and wherein in response to the live agent not adopting the predicted recommendation, further comprising to analyze the knowledge base for content gaps related to the question.

Example 19 includes the subject matter of Examples 1-18, and wherein to analyze the knowledge base for content includes analyzing a transcription of the call between the customer and the live agent concerning the question.

Example 20 includes the subject matter of Examples 1-19, and further comprising to identify, with the RAG system, one or more products and/or services predicted to be of interest to the customer based on a customer’s profile.

Example 21 includes a method comprising receiving, with a compute device, a call in which a customer poses a question to a live agent; providing, with a compute device, the question in real-time to a retrieval augmented generation artificial intelligence system (“RAG system”); retrieving, with the RAG system, relevant context from a knowledge base related to the question; generating, by the RAG system, a predicted recommendation in response to the question based on the relevant context from the knowledge base; and providing, by the RAG system, the predicted recommendation to the live agent.

Example 22 includes the subject matter of Example 21, and wherein providing the question to the RAG system comprises providing a live audio stream of the call from the customer to the RAG system.

Example 23 includes the subject matter of Examples 21 and 22, and wherein providing the question to the RAG system comprises providing an audio clip of the call from the customer to the RAG system.

Example 24 includes the subject matter of Examples 21-23, and wherein providing the question to the RAG system comprises providing a live multimedia stream of the call from the customer to the RAG system.

Example 25 includes the subject matter of Examples 21-24, and further comprising performing input processing on the live audio stream of the call from the customer.

Example 26 includes the subject matter of Examples 21-25, and wherein performing input processing comprises to convert, with one or more large language models, the live audio stream of the call from the customer to text.

Example 27 includes the subject matter of Examples 21-26, and wherein receiving relevant context from the knowledge base comprises retrieving relevant context from a customer’s profile representing data specific to the customer that provided the question, and the RAG system generates the predicted recommendation that is personalized to the customer’s profile.

Example 28 includes the subject matter of Examples 21-27, and wherein receiving relevant context from the customer profile comprises identifying the customer with a unique identifier representing the customer.

Example 29 includes the subject matter of Examples 21-28, and wherein the customer’s profile includes data identifying one or more financial accounts associated with the customer with a financial institution associated with the live agent, and the RAG system generates the predicted recommendation personalized to the one of more financial accounts associated with the customer.

Example 30 includes the subject matter of Examples 21-29, and wherein receiving relevant context from the knowledge base comprises retrieving relevant context from an enterprise knowledge base.

Example 31 includes the subject matter of Examples 21-30, and wherein the enterprise knowledge base comprises policies, processes and/or procedures of a financial institution.

Example 32 includes the subject matter of Examples 21-31, and wherein receiving relevant context from the knowledge base comprises retrieving relevant context from one or more prior interactions of the customer with the RAG system.

Example 33 includes the subject matter of Examples 21-32, and further comprising determining whether the one or more prior interactions of the customer with the RAG system provide sufficient context for the RAG system to directly answer the customer’s question without involvement by the live agent.

Example 34 includes the subject matter of Examples 21-33, and wherein in response to determining there is sufficient context for the RAG system to directly answer the customer’s question, providing the predicted recommendation directly to the customer from one or more large language models.

Example 35 includes the subject matter of Examples 21-34, and wherein providing the predicted recommendation directly to the customer comprises generating, by the one or more large language models, an audio response to the customer with the predicted recommendation.

Example 36 includes the subject matter of Examples 21-35, and further comprising determining whether the live agent adopts the predicted recommendation.

Example 37 includes the subject matter of Examples 21-36, and wherein in response to the live agent adopting the predicted recommendation, updating the knowledge base with the predicted recommendation.

Example 38 includes the subject matter of Examples 21-37, and wherein in response to the live agent not adopting the predicted recommendation, further comprising analyzing the knowledge base for content gaps related to the question.

Example 39 includes the subject matter of Examples 21-38, and wherein analyzing the knowledge base for content includes analyzing a transcription of the call between the customer and the live agent concerning the question.

Example 40 includes the subject matter of Examples 21-39, and further comprising identifying, with the RAG system, one or more products and/or services predicted to be of interest to the customer based on a customer’s profile.

Example 41 includes one or more machine-readable storage media comprising a plurality of instructions stored thereon that, in response to being executed, cause a compute device to: receive, through a real-time communication channel, a call in which a customer poses a question to a live agent; provide the question in real-time to a retrieval augmented generation artificial intelligence system (“RAG system”); retrieve, with the RAG system, relevant context from a knowledge base related to the question; generate, by the RAG system, a predicted recommendation in response to the question based on the relevant context from the knowledge base; and provide, by the RAG system, the predicted recommendation to the live agent.

Example 42 includes the subject matter of Example 41, and wherein to provide the question to the RAG system comprises providing a live audio stream of the call from the customer to the RAG system.

Example 43 includes the subject matter of Examples 41 and 42, and wherein to provide the question to the RAG system comprises providing an audio clip of the call from the customer to the RAG system.

Example 44 includes the subject matter of Examples 41-43, and wherein to provide the question to the RAG system comprises providing a live multimedia stream of the call from the customer to the RAG system.

Example 45 includes the subject matter of Examples 41-44, and further comprising to perform input processing on the live audio stream of the call from the customer.

Example 46 includes the subject matter of Examples 41-45, and wherein to perform input processing comprises to convert, with one or more large language models, the live audio stream of the call from the customer to text.

Example 47 includes the subject matter of Examples 41-46, and wherein to receive relevant context from the knowledge base comprises to retrieve relevant context from a customer’s profile representing data specific to the customer that provided the question, and the RAG system is to generate the predicted recommendation that is personalized to the customer’s profile.

Example 48 includes the subject matter of Examples 41-47, and wherein to receive relevant context from the customer profile comprises identifying the customer with a unique identifier representing the customer.

Example 49 includes the subject matter of Examples 41-48, and wherein the customer’s profile includes data identifying one or more financial accounts associated with the customer with a financial institution associated with the live agent, and the RAG system is to generate the predicted recommendation personalized to the one of more financial accounts associated with the customer.

Example 50 includes the subject matter of Examples 41-49, and wherein to receive relevant context from the knowledge base comprises to retrieve relevant context from an enterprise knowledge base.

Example 51 includes the subject matter of Examples 41-50, and wherein the enterprise knowledge base comprises policies, processes and/or procedures of a financial institution.

Example 52 includes the subject matter of Examples 41-51, and wherein to receive relevant context from the knowledge base comprises to retrieve relevant context from one or more prior interactions of the customer with the RAG system.

Example 53 includes the subject matter of Examples 41-52, and further comprising instructions to determine whether the one or more prior interactions of the customer with the RAG system provide sufficient context for the RAG system to directly answer the customer’s question without involvement by the live agent.

Example 54 includes the subject matter of Examples 41-53, and wherein in response to determining there is sufficient context for the RAG system to directly answer the customer’s question, provide the predicted recommendation directly to the customer from one or more large language models.

Example 55 includes the subject matter of Examples 41-54, and wherein to provide the predicted recommendation directly to the customer comprises generating, by the one or more large language models, an audio response to the customer with the predicted recommendation.

Example 56 includes the subject matter of Examples 41-55, and further comprising instructions to determine whether the live agent adopts the predicted recommendation.

Example 57 includes the subject matter of Examples 41-56, and wherein in response to the live agent adopting the predicted recommendation, updating the knowledge base with the predicted recommendation.

Example 58 includes the subject matter of Examples 41-57, and wherein in response to the live agent not adopting the predicted recommendation, further comprising to analyze the knowledge base for content gaps related to the question.

Example 59 includes the subject matter of Examples 41-58, and wherein to analyze the knowledge base for content includes analyzing a transcription of the call between the customer and the live agent concerning the question.

Example 60 includes the subject matter of Examples 41-59, and further comprises instructions to identify, with the RAG system, one or more products and/or services predicted to be of interest to the customer based on a customer’s profile.

1. A compute device comprising:
circuitry configured to:
receive, through a real-time communication channel, a call in which a customer poses a question to a live agent;
provide the question in real-time to a retrieval augmented generation artificial intelligence system (“RAG system”);
retrieve, with the RAG system, relevant context from a knowledge base related to the question;
generate, by the RAG system, a predicted recommendation in response to the question based on the relevant context from the knowledge base; and
provide, by the RAG system, the predicted recommendation to the live agent.

2. The compute device of claim 1, wherein to provide the question to the RAG system comprises providing one or more of (i) a live audio stream, (ii) an audio clip, and/or (iii) a live multimedia stream of the call from the customer to the RAG system.

3. The compute device of claim 2, further comprising to perform input processing on the live audio stream of the call from the customer by converting, with one or more large language models, the live audio stream of the call from the customer to text.

4. The compute device of claim 1, wherein to retrieve relevant context from the knowledge base comprises to retrieve relevant context from a customer’s profile representing data specific to the customer that provided the question, and the RAG system is to generate the predicted recommendation that is personalized to the customer’s profile.

5. The compute device of claim 4, wherein to retrieve relevant context from the customer profile comprises identifying the customer with a unique identifier representing the customer.

6. The compute device of claim 5, wherein the customer’s profile includes data identifying one or more financial accounts associated with the customer with a financial institution associated with the live agent, and the RAG system is to generate the predicted recommendation personalized to the one of more financial accounts associated with the customer.

7. The compute device of claim 1, wherein to retrieve relevant context from the knowledge base comprises to retrieve relevant context from an enterprise knowledge base comprising policies, processes, and/or procedures of a financial institution.

8. The compute device of claim 1, wherein to retrieve relevant context from the knowledge base comprises to retrieve relevant context from one or more prior interactions of the customer with the RAG system.

9. The compute device of claim 8, further comprising to determine whether the one or more prior interactions of the customer with the RAG system provide sufficient context for the RAG system to directly answer the customer’s question without involvement by the live agent.

10. The compute device of claim 9, wherein in response to determining there is sufficient context for the RAG system to directly answer the customer’s question, provides the predicted recommendation directly to the customer from one or more large language models.

11. The compute device of claim 10, wherein to provide the predicted recommendation directly to the customer comprises generating, by the one or more large language models, an audio response to the customer with the predicted recommendation.

12. The compute device of claim 1, further comprising to determine whether the live agent adopts the predicted recommendation, wherein in response to the live agent adopting the predicted recommendation, updating the knowledge base with the predicted recommendation.

13. The compute device of claim 12, wherein in response to the live agent not adopting the predicted recommendation, further comprising to analyze the knowledge base for content gaps related to the question.

14. The compute device of claim 13, wherein to analyze the knowledge base for content includes analyzing a transcription of the call between the customer and the live agent concerning the question.

15. The compute device of claim 1, further comprising to identify, with the RAG system, one or more products and/or services predicted to be of interest to the customer based on a customer’s profile.

16. A method comprising:
receiving, with a compute device, a call in which a customer poses a question to a live agent;
providing, with a compute device, the question in real-time to a retrieval augmented generation artificial intelligence system (“RAG system”) by providing one or more of (i) a live audio stream, (ii) an audio clip, and/or (iii) a live multimedia stream of the call from the customer to the RAG system;
retrieving, with the RAG system, relevant context from a knowledge base related to the question;
determining whether there is sufficient relevant context for the RAG system to directly answer the customer’s question,
in response to determining there is sufficient context for the RAG system to directly answer the customer’s question, providing a predicted recommendation generated by the RAG system directly to the customer using one or more large language models (LLMs) without any further involvement by the live agent; and
in response to determining there is insufficient context for the RAG system to directly answer the customer’s question, providing the predicted recommendation to the live agent.

17. The method of claim 16, wherein retrieving relevant context from the knowledge base comprises retrieving relevant context from a customer’s profile representing data specific to the customer, and the RAG system generates the predicted recommendation that is personalized to the customer’s profile.

18. The method of claim 16, wherein the customer’s profile includes data identifying one or more financial accounts associated with the customer with a financial institution associated with the live agent, and the RAG system generates the predicted recommendation personalized to the one or more financial accounts associated with the customer.

19. The method of claim 16, wherein retrieving relevant context from the knowledge base comprises retrieving relevant context from one or more prior interactions of the customer with the RAG system.

20. The method of claim 16, further comprising determining whether the live agent adopts the predicted recommendation, wherein in response to the live agent adopting the predicted recommendation, updating the knowledge base with the predicted recommendation, wherein in response to the live agent not adopting the predicted recommendation, further comprising analyzing the knowledge base for content gaps related to the question.
